(19) United States
(12) Patent Application Publication
(10) Pub. No.: US 2026/0322178 A1
(43) Pub. Date: Oct. 15, 2026

(54) CONDITIONAL STANDBY STATE IN A WIRELESS POWER SYSTEM

(71) Applicant: DOLBY INTELLECTUAL PROPERTY LICENSING, LLC

(72) Inventors: JAYANTI GANESH, Bengaluru (IN); VISWANATHAN KANAKASABAI, Bengaluru (IN); SUBBARAO TATIKONDA, Bengaluru (IN); Suma Memana NARAYANA BHAT, Bengaluru (IN)

(73) Assignee: DOLBY INTELLECTUAL PROPERTY LICENSING, LLC, (US)

(21) Appl. No.: 19/485,621

(22) PCT Filed: May 21, 2024
(86) PCT No.: PCT/US2024/030373

§ 371 Date: Nov. 18, 2025

(30) Foreign Application Priority Data
May 22, 2023 (IN) 202311035620

(51) Int. Cl. H02J 50/80; H02J 50/00; H02J 50/12; H05B 1/02

(52) U.S. Cl. CPC H02J 50/80; H02J 50/005; H02J 50/12; H05B 1/0258

(57) ABSTRACT

This disclosure provides systems, methods and apparatuses for a conditional standby state in a wireless power system. A Power Receiver can communicate a request message to a Power Transmitter to initiate a conditional standby state. During the conditional standby state, the Power Receiver can temporarily discontinue communication, power harvesting, or other operations for a period of time referred to as a sleeping time. At expiration of the sleeping time, the Power Transmitter can wake the Power Receiver so that the Power Receiver can check status of a condition of the appliance. Based on the status of the condition, the Power Receiver might request a transition to the power state for an ON action or might request a further conditional standby state for an OFF action. The wireless power system can use the conditional standby state to implement conditional ON or OFF actions of an appliance.

### TECHNICAL FIELD

This disclosure relates generally to wireless power and some aspects relate to state transitions in a wireless power system based on conditional ON and OFF actions of an appliance.

### DESCRIPTION OF RELATED TECHNOLOGY

A wireless power system includes a Power Transmitter (PTx) and a Power Receiver (PRx). Inductive coupling can enable wireless power transfer between a primary coil of the Power Transmitter and a secondary coil of the Power Receiver. The primary coil of the Power Transmitter produces an electromagnetic field during a power state of the wireless power system. The electromagnetic field induces a voltage in the secondary coil of the Power Receiver when the secondary coil is present in the electromagnetic field. The Power Receiver can use the induced voltage (either directly or via a rectifier) to power a load. Example loads might include a motor, a heating element, electronics, or a power storage device, among other examples. In an example kitchen environment, a magnetic power source (such as a kitchen hob) might include one or more Power Transmitters. An appliance (such as a cordless kitchen appliance) might include a Power Receiver as well as the load. The appliance can be placed on a Power Transmitter such that the Power Receiver of the appliance can receive wireless power from the magnetic power source,

Some appliances operate based on user interaction to control ON and OFF operations. For example, some blenders or juicers might be designed with a button or other user interface for manual control to tum the appliance ON when the user intends to use them. This ensures that power is not wasted and that the appliance operates only when needed. Other appliances might be designed to turn ON or OFF automatically to reduce user interaction. For instance, appliances like rice cookers, kettles, and coffee makers might be designed to automatically tum ON or OFF to beat food or liquid contents according to a schedule or temperature criteria. Current techniques for managing automatic ON and OFF operation of an appliance require the Power Transmitter and the Power Receiver to consume power during the OFF periods of operation.

### BRIEF SUMMARY

The systems, methods, and apparatuses of this disclosure each have several innovative aspects, no single one of which is solely responsible for the desirable attributes disclosed herein.

One aspect of the present disclosure can be implemented as a method by a Power Transmitter of a wireless power system. The method includes communicating with a Power Receiver of an apparatus. The method includes transitioning to a standby state based on a first request from the Power Receiver to enter a conditional standby state. The method includes waking the Power Receiver after expiration of a sleeping time for the conditional standby state. The method includes receiving one or more communications from the Power Receiver after waking the Power Receiver. The method includes transitioning to a power state when the one or more communications include a power request message from the Power Receiver.

Another aspect of the present disclosure can be implemented as a method by a Power Receiver of an apparatus for use in a wireless power system. The method includes communicating, to a Power Transmitter, a first request to transition to a conditional standby state. The method includes receiving bias power from the Power Transmitter after expiration of a sleeping time for the conditional standby state. The method includes communicating one or more communications to the Power Transmitter after receiving the bias power. The one or more communications are configured to cause the Power Transmitter to either transition to a power state or return to the conditional standby state.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE SEVERAL VIEWS OF THE DRAWINGS

Like reference numbers and designations in the various drawings indicate like elements. Note that the relative dimensions of the figures may not be drawn to scale.

FIG. 1 shows a pictorial diagram of example wireless power transfer systems,

FIG. 2 is a block diagram of an example wireless power system.

FIG. 3 illustrates a state diagram of a wireless power system.

FIG. 4 illustrates an example temperature plot associated with an appliance that might implement aspects of the present disclosure.

FIG. 5 illustrates an example Power Receiver in accordance with aspects of this disclosure.

FIG. 6 illustrates a first example wake sequence of a wireless power system.

FIG. 7 illustrates a second example wake sequence of a wireless power system.

FIG. 8 illustrates a timing diagram and associated operations in various states of a wireless power system.

FIG. 9 depicts a conceptual diagram of an example message according to some aspects of this disclosure.

FIG. 10 illustrates a flow chart with example operations of a Power Transmitter in accordance with some aspects of this disclosure.

FIG. 11 illustrates a flow chart with example operations of a Power Receiver in accordance with some aspects of this disclosure.

FIG. 12 illustrates a block diagram of an example apparatus for use in a wireless power system.

### DETAILED DESCRIPTION

The following description is directed to certain implementations for the purpose of describing innovative aspects of this disclosure. However, a person having ordinary skill in the art will readily recognize that the teachings herein can be applied in a multitude of different ways. The described implementations can be implemented in any means, apparatus, system, or method for transmitting or receiving wireless power.

A wireless power system includes a Power Transmitter (PTx) and a Power Receiver (PRx). A Power Transmitter also may be referred to as a wireless power transmission apparatus. A Power Receiver also may be referred to as a wireless power reception apparatus. Some examples of this disclosure are based on a kitchen environment. For example, the Power Transmitter might be part of a magnetic power source such as a hob, a countertop, or range. In some implementations, the Power Transmitter may include a surface-mounted primary coil, an integrated primary coil, a countertop-mounted primary coil or a primary coil that is embedded or manufactured in a surface on which a Power Receiver can be placed. A Power Receiver includes a secondary coil configured to wirelessly receive power via inductive coupling with the primary coil of the Power Transmitter. The Power Receiver might be part of a cordless appliance such as a cordless blender, kettle, toaster, or cooking vessel, among other examples. Although the examples of this disclosure refer to a wireless power system in a kitchen environment, the disclosed techniques can be used with other types of wireless power systems or in other types of environments.

Some appliances might be designed to automatically turn ON or OFF according to a schedule or temperature criteria. For an example, an appliance might obtain wireless power to perform a heating operation (such as cooking food or boiling a liquid, as examples). In some instances, it is desirable for the appliance to automatically turn ON at a particular time so that the heating operation is performed according to an end-user schedule. The appliance might be configured to turn OFF once the heating operation is complete. In some instances, it is desirable for the appliance to automatically turn ON for a warming or reheating operation or to maintain a target temperature. Current techniques for managing automatic ON and OFF operation of an appliance are based on control messaging from the appliance to the Power Transmitter. For example, the appliance might remain in a connected state of operation when not receiving wireless power for the heating or reheating operations.

In the connected state, the appliance consumes power from the Power Transmitter to maintain periodic communication, controller operations, and sensor measurements. Thus, the appliance will continue to consume power during the OFF periods of operation. In some implementations, the appliance uses bias power harvested from a Near Field Communication (NFC) signal from a communication interface of the Power Transmitter to maintain the connected state and sensor measurements during the OFF periods of operation. Thus, the appliance relies on NFC-harvested power from the Power Transmitter, which prevents the Power Transmitter and the Power Receiver to enter a standby mode. As a result. power is consumed, even during periods of inactivity, leading to inefficiencies and unnecessary power usage. In some cases, the power usage might violate standby power requirements prescribed by regulatory agencies. A wireless power system can be improved by enabling the Power Transmitter and the Power Receiver to enter a conditional standby state during periods of inactivity.

This disclosure provides systems, methods and apparatuses for a conditional standby state in a wireless power system. A conditional standby state also might be referred to as a “standby state with wake up,” a “temporary standby state,” a “sleep state,” a “dormant state,” or simply as a “standby state” for brevity, A Power Receiver can initiate the conditional standby state using a request message to the Power Transmitter. For example, the Power Receiver can request the conditional standby state based on a schedule or temperature criteria to implement a conditional OFF period. During the conditional standby state, the Power Transmitter and the Power Receiver can temporarily discontinue communication, power harvesting, or other operations. The conditional standby state can result in a low or no power consumption for a period of time referred to as a sleeping time. Other terms for the sleeping time might include a standby time, a conditional standby time, a conditional sleeping time, a dormant period, or other terms to refer to a time during which the Power Transmitter temporarily ceases communication with the Power Receiver and the Power Receiver temporarily ceases consumption of power provided by the Power Transmitter. The conditional standby state also may be referred to as a temporary standby state, a sleep state, a dormant state, or other terms to refer to a state of operation during the sleeping time.

Aspects of this disclosure enable state transitions in a wireless power system based on conditional ON and OFF actions of an appliance. The Power Receiver can request the conditional standby state for a sleeping time associated with an OFF action of the appliance. At expiration of the sleeping time, the Power Transmitter can wake the Power Receiver. The Power Receiver can determine if a condition of the appliance warrants an ON action, such as a schedule or target temperature. In some implementations, the conditional standby state can occur before the first instance of the power state. Thus, the Power Receiver can be placed on the Power Transmitter and implement a conditional standby state to minimize power consumption and communication until a condition (such as a schedule) is satisfied to automatically begin an ON action. In some implementations, the conditional standby state can occur between instances of the power state. For example, the appliance may be configured to maintain a target temperature after an initial heating operation. The appliance might alternate between ON and OFF actions to maintain the target temperature. During the OFF actions, the conditional standby state can reduce the communication and power consumption within the wireless power system.

In some aspects, the Power Receiver can request the conditional standby state during periods of OFF actions. After expiration of the sleeping time for each instance of the conditional standby state, the Power Transmitter can wake the Power Receiver. Waking the Power Receiver might include establishment of communication and transmission of communication signals from which the Power Receiver can harvest bias power to operate a sensor and controller. The harvested bias power may be sufficient for the Power Receiver to determine whether to initiate an ON action (which may be referred to as a conditional ON action). The Power Receiver may initiate the conditional ON action based on one or more criteria. Thus, the Power Receiver can periodically check the status of a condition associated with one or more criteria. Meanwhile, the Power Receiver can minimize operation and power consumption during the sleeping time between periodically checking the status of the condition. The one or more criteria may be based on a condition such as a schedule or a temperature of the apparatus becoming cooled below a temperature threshold. If the one or more criteria are not met, the Power Receiver can request another conditional standby state and re-check the condition the next time the Power Transmitter wakes the Power Receiver. Alternatively, if the one or more criteria are met, the Power Receiver can request a power state for an ON action.

Particular implementations of the subject matter described in this disclosure can be implemented to realize one or more of the following potential advantages. The techniques of this disclosure can result in improved power efficiency, reduced standby power consumption, optimized operational states, seamless reheating processes, dynamic scheduling, and enhanced control for appliances that support conditional ON and OFF actions. By implementing “wake up” sequences and negotiating sleeping times, the wireless power system can optimize power consumption, allow the Power Transmitter and the appliance to enter a conditional standby state during periods of inactivity.

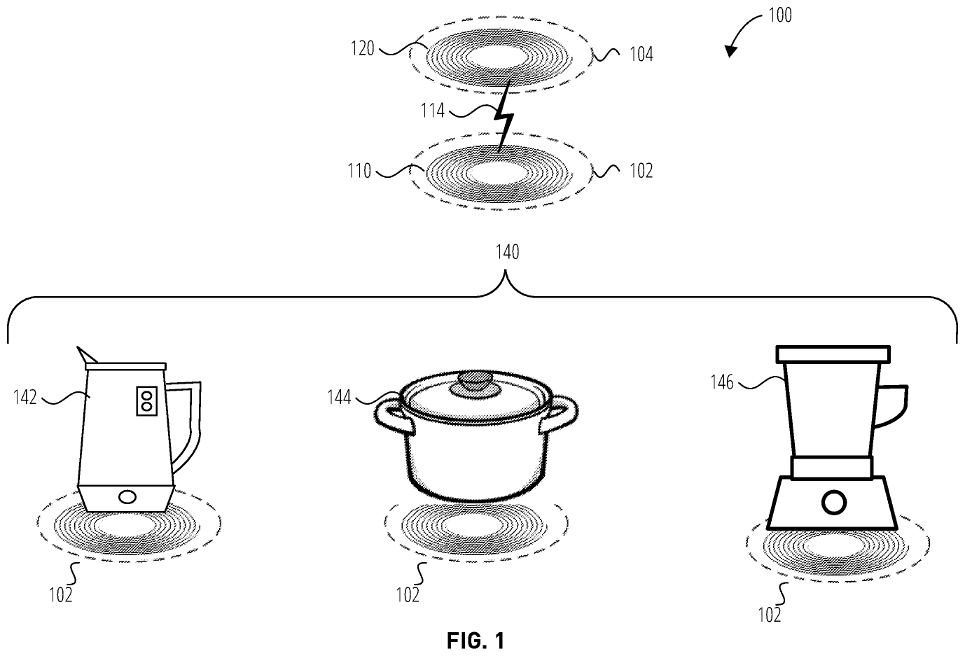

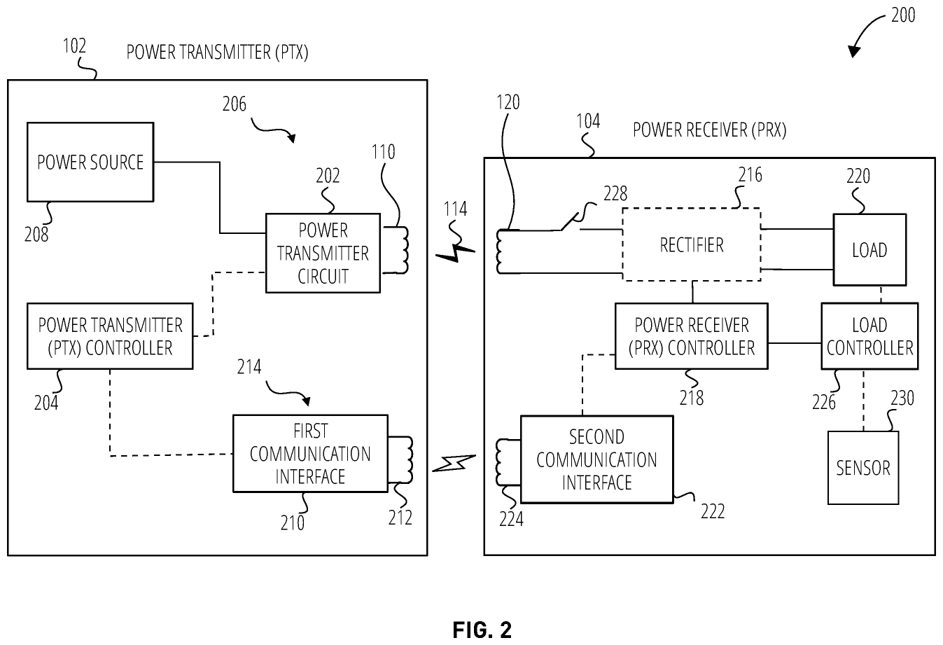

FIG. 1 shows a pictorial diagram of example wireless power transfer systems 100. The wireless power transfer system may include a Power Transmitter 102 and a Power Receiver 104. The Power Transmitter 102 includes a primary coil 110. When the primary coil 110 transmits the wireless power 114, it creates a magnetic field that induces a voltage in a secondary coil 120 of the Power Receiver 104. The Power Receiver 104 may include a secondary coil 120 configured to receive the wireless power 114. The components of the Power Transmitter 102 and the Power Receiver 104 are described in further detail with reference to FIG. 2.

Continuing with FIG. 1, the Power Receiver 104 may be associated with an appliance (such as a cordless kitchen appliance, among other examples) may be intended to operate on a wireless power transmitting surface configured with one or more primary coils (such as a kitchen countertop, stovetop, or hob). FIG. 1 shows some examples 140 of appliances that may be used with a Power Transmitter 102. For example, the appliance may be a kettle 142, a slow cooker 144, or a blender 146. Other types of appliances that may include a Power Receiver may include a pot, a rice cooker, a coffee machine, a toaster, a broiler, a griddle, an electric pan, any type of appliance configured to heat a liquid or food, among other examples. The Power Transmitter 102 may be included in a kitchen equipment such as a cooktop or hob. For example, in some implementations, a hob may include several locations for placement of objects. At least one of the locations may include a Power Transmitter 102 that supports wireless power transfer to an appliance that includes a Power Receiver 104. In some implementation, a Power Transmitter 102 may be integrated in a hob that is portable in nature. For example, a portable hob may include a battery or be capable of an external power source to power the Power Transmitter 102, and may be suitable for camping.

Some appliances (such as blender 146) might be configured to only turn ON based on user interaction so that the end user manually controls when the appliance is being used. Other appliances may implement conditional periods of ON and OFF actions. For example, the kettle 142 might be configured to automatically turn ON according to a scheduled start time and automatically turn OFF once a heating operation is completed. In another example, the slow cooker 144 might be configured to turn ON to heat up to the first temperature and then turn OFF when the first temperature is reached. In some examples, the slow cooker 144 (or other appliance) might be configured to reheat, maintain or “keep warm” at a target temperature. The slow cooker 144 could be configured to automatically turn OFF for a period of time when the current temperature is above the target temperature and automatically turn ON when the current temperature is at or below the target temperature. Such conditional ON and OFF actions can be implemented to minimize user interaction. It is also desirable to minimize power consumption during periods associated with OFF actions, such as during cooling periods between warming periods (ON action) of the appliance. This disclosure describes techniques for implementing a conditional standby state that can reduce or eliminate power consumption by the appliance during the OFF actions while also enabling the appliance to occasionally check a status of a condition to determine whether to initiate an ON action.

FIG. 2 is a block diagram of an example wireless power system 200. The example wireless power system 200 includes a Power Transmitter 102 and a Power Receiver 104. The Power Transmitter 102 includes a primary coil 110 and a PTx controller 204. The primary coil 110 may be associated with a Power Transmitter circuit 202 (sometimes also referred to as a power signal generator, or a driver circuit, or a driver). The primary coil 110 may be a wire coil which transmits wireless power (which also may be referred to as wireless energy). The primary coil 110 may transmit wireless energy using an inductive or a resonant magnetic field. The Power Transmitter circuit 202 may include components (not shown) to prepare the wireless power. For example, the Power Transmitter circuit 202 may include one or more switches, drivers, series capacitors, rectifiers, inverters, or other components. In some implementations, the Power Transmitter circuit 202, PTx controller 204 and other components (not shown) may be collectively referred to as a power transmitter unit 206. Some or all of the power transmitter unit 206 may be embodied as an integrated circuit (IC) that implements features of this disclosure. The PTx controller 204 may be implemented as a microcontroller, dedicated processor, integrated circuit, application specific integrated circuit (ASIC) or any other suitable electronic device.

A power source 208 provides power to the power transmitter unit 206. In some implementations, the power source 208 may convert alternating current (AC) power to direct current (DC) power. For example, the power source 208 may include a converter that receives an AC power from an external power supply and converts the AC power to a DC power used by the Power Transmitter circuit 202. Alternatively, or additionally, a component (such as an inverter) of the Power Transmitter circuit 202 may convert the DC power to the AC power. The power source 208 may be integrated as part of the Power Transmitter 102 or may be external to the Power Transmitter 102. In some implementations, the Power Transmitter 102 causes the power source 208 to regulate the DC output voltage of the power source 208. For example, the PTx controller 204 can set DC voltage of the power source 208 based on information (such as a value indicating a requested power) received from the Power Receiver 104. The Power Transmitter 102 can receive power configuration information from the Power Receiver 104 and use the information to set a parameter (such as the DC output voltage of the power source 208). The Power Transmitter 102 can receive the power configuration information during various operating states, such as the discovery state or power state. In some implementations, the Power Transmitter 102 includes a DC-DC converter (not shown) between the power source 208 and the Power Transmitter circuit 202 to control the variable DC output voltage.

The PTx controller 204 is connected to a first communication interface 210. The first communication interface 210 is connected to a first communication coil 212. In some implementations, the first communication interface 210 and the first communication coil 212 may be collectively referred to as the first communication unit 214. In some implementations, the first communication unit 214 may support short-range radio frequency communication, such as Near-Field Communication (NFC) or Bluetooth (BT). NFC is a technology by which data transfer occurs on a carrier frequency of 13.56 Megahertz (MHz). The first communication unit 214 also may support any suitable communication protocol. The first communication unit 214 may contain modulation and demodulation circuits to wirelessly communicate via the first communication coil 212. Alternatively, or additionally, the PTx controller 204 may use frequency, amplitude, current, or voltage modulation of a wireless power signal to communicate via an in-band communication link (not shown) that includes the primary coil 110.

The Power Receiver 104 may include a secondary coil 120, a rectifier 216, a PRx controller 218, a second communication interface 222, a load controller 226, a load 220, and a memory (not shown). In some implementations, the load 220 can include a driver (not shown) for controlling at least one parameter such as charging current, speed, or torque of the load. In some implementations, the rectifier 216 may be omitted such as when the voltage induced in the secondary coil 120 can directly power the load 220. Although not shown in FIG. 2, a capacitor is present in series with the secondary coil 120. Although not shown, a load capacitance can be used after the rectifier 216 to filter a high frequency component of the rectifier voltage. Although shown as different components, some components may be packaged or implemented in the same hardware. For example, in some implementations, the PRx controller 218 and the load controller 226 may be implemented as a single controller. The PRx controller 218, the load controller 226, or any combination thereof, may be implemented as a microcontroller, dedicated processor, integrated circuit, application specific integrated circuit (ASIC) or any other suitable electronic device.

The PTx controller 204 may detect the presence or proximity of a Power Receiver 104. This detection may happen during a periodic pinging process of the first communication interface 210. During the pinging process, the first communication interface 210 also may supply power to the second communication interface 222 when the Power Receiver 104 is in proximity to the Power Transmitter 102. The second communication interface 222 may “wake up” and power-up the PRx controller 218 and may send a reply signal back to the first communication interface 210. Prior to power transfer, a handshaking process may take place during which the PTx controller 204 may receive identification and configuration data, among other information, from the Power Receiver 104. The PTx controller 204 may control characteristics of wireless power it provides to the Power Receiver 104 based on the configuration data.

A PRx controller 218 may be operationally coupled to the rectifier 216 and the second communication interface 222. The second communication interface 222 may contain modulation and demodulation circuits to wirelessly communicate via the second communication coil 224. Thus, the PRx controller 218 may wirelessly communicate feedback information to the PTx controller 204 via the second communication interface 222 to the first communication interface 210 using short-range radio frequency communication, such as NFC. Alternatively, or additionally, the PRx controller 218 may use load modulation to communicate via an in-band communication link (not shown) that includes the secondary coil 120.

A load controller 226 may be operationally coupled to the load 220 and the second communication interface 222. The load controller 226 may detect changes to load states such as change in charging currents in a battery charging application. The load controller 226 also may determine a load voltage reference. The load controller 226 also may send load voltage references, load current, and any other suitable information to the PRx controller 218 or the second communication interface 222 for communication to the Power Transmitter 102. During a power state, the PRx controller 218 may additionally determine and provide feedback information indicating a measured load voltage available to the load 220. In some feedback messages, the feedback information may include a reference voltage indicating a required voltage for the load 220. In some feedback messages, the feedback information may indicate an error in the output voltage of the load 220. In some feedback messages, the feedback information may include the required power for the load. Although the PRx controller 218 and load controller 226 are shown separately, they may be included in the same component of the Power Receiver 104.

Some appliances are equipped with safety features, such as a disconnect switch 228, that are operated in conjunction with the operating states. For example, the disconnect switch 228 might be maintained in an open position to prevent the flow of current to the load 220 when the Power Receiver 104 is in the pre-power states (the standby state, the discovery state, and the connected state). Before transitioning to the power state, the PRx controller 218 might cause the disconnect switch 228 to move to a closed position to enable the flow of current to the load 220. In an emergency condition (such as excessive voltage or current). the PRx controller 218 might open the disconnect switch 228 to prevent damage to the load 220 or other components of the Power Receiver 104.

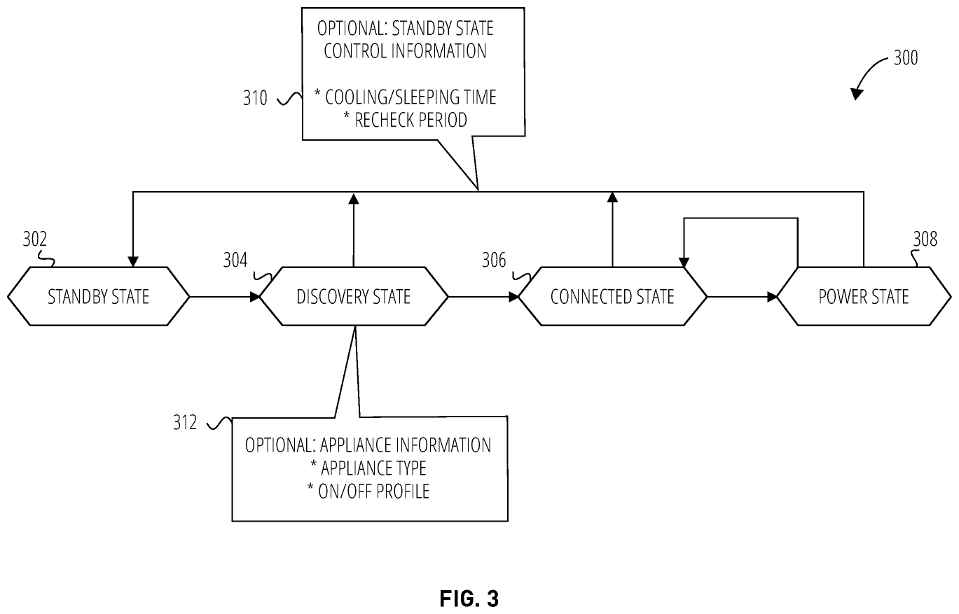

FIG. 3 illustrates a state diagram 300 of a wireless power system. The state diagram 300 illustrates the operating states in which the wireless power system may operate. When a Power Receiver is placed within an operating volume on the interface surface of a Power Transmitter, the two start to communicate with the aim to configure and control the power transfer. There can be four operating states associated with the wireless power system: a standby state 302 (sometimes also referred to as a ping phase), a discovery state 304 (sometimes referred to as an identification phase), a connected state 306, and a power state 308 (sometimes referred to as a power transfer phase). The standby state 302, the discovery state 304, and the connected state 306 can collectively be referred to as pre-power states. A technical specification may define how the Power Transmitter and Power Receiver can transition between the operating states. For example, the wireless power system typically begins in the standby state 302 until the Power Transmitter detects a Power Receiver, moving it to the discovery state 304. In the discovery state 304, the Power Transmitter establishes communication and receives the first identification information of the Power Receiver and its static configuration data. In the connected state 306 and the power state 308, the Power Transmitter and Power Receiver exchange information to agree and adjust parameters related to wireless power transfer. The system can move to a reinitialization state (not shown) as needed to reinitialize or return to the standby state when communication, powering, or other activities are no longer taking place. Each of the operating states are briefly described herein for reference.

In the standby state 302, the Power Transmitter tries to establish communications with a Power Receiver. The Power Receiver may be just placed on the interface surface or may not be present during this operating state. The Power Transmitter may attempt to communicate or detect the presence of the Power Receiver. For example, the Power Transmitter may use an analog ping, out-of-band communication (such as NFC), a digital ping, or any combination thereof, to determine that a compatible Power Receiver is present. Once the wireless power system determines that a Power Receiver is present (such as by confirming NFC communication), the wireless power system may transition to the discovery state 304.

In the discovery state 304, the Power Receiver may establish communication with the Power Transmitter and send static configuration information (such as identification and configuration information) to the Power Transmitter. For example, the Power Transmitter may retrieve static configuration information from the Power Receiver via the NFC communication. The Power Transmitter and the Power Receiver may use this information to verify that they both use compatible versions of a technical specification or protocol for wireless power transfer. The Power Transmitter and Power Receiver may communicate basic settings or communicate regarding their respective capabilities. From the discovery state 304, the wireless power system may transition to the connected state 306.

In the connected state 306, the Power Transmitter and the Power Receiver may exchange further communications to negotiate the parameters that govern the power state. For example, a power negotiation can occur during the connected state 306. After negotiating the parameters, the Power Transmitter may be prepared to transfer wireless power and the Power Receiver may be prepared to receive the wireless power. The Power Transmitter may wait for a request or command from the Power Receiver before transitioning to the power state 308. This may be useful, for example, when a cordless appliance (such as a blender, toaster, mixer, or microwave, among other examples) is configured for use pending a user interaction. The user may initiate the power state 308 by a user interface (such as an activation switch) of the Power Receiver, which in turn communicates to the Power Transmitter to transition to the power state 308.

As described in this disclosure, a wireless power system can implement a conditional standby state. The conditional standby state can be similar to standby state 302. However, the conditional standby state can be associated with a sleeping time such that the Power Receiver, the Power Transmitter, or both, can be dormant during the sleeping time. At expiration of the sleeping time, the Power Transmitter can wake the Power Receiver. Waking the Power Receiver includes establishing communication from the Power Transmitter to the Power Receiver. For example, the Power Transmitter can initiate a ping via NFC. The NFC signal can provide bias power to operate the communication interface and the PRx controller (such as the second communication interface 222 and the PRx controller 218, respectively. described with reference to FIG. 2).

In some implementations, waking the Power Receiver can include moving to the discovery state 304 and/or the connected state 306. For example, the Power Transmitter might perform one or more operations associated with a discovery state 304 and/or the connected discovery state 304. The one or more operations might include performing a foreign object detection (FOD) procedure to determine whether a foreign object has been introduced to the operating environment of the Power Transmitter during the sleeping time.

In some implementations, if the Power Transmitter determines that the Power Receiver is present in the operating environment and that no foreign object is detected by the FOD, the Power Transmitter might omit an operation of the discovery state 304 or the connected state 306 that would otherwise be performed the first time a Power Receiver is placed on the Power Transmitter. For example, the Power Transmitter might determine that the Power Receiver is the same as previously detected before the conditional standby state based on a matching device identification or other indicia. The Power Transmitter might omit an authentication, one or more configuration messages, or a power negotiation message exchange, among other examples.

In some implementations, if the Power Transmitter determines that the Power Receiver is moved, that the Power Receiver is no longer present in an operating environment of the Power Transmitter, or that a foreign object has been introduced during the conditional standby state, the Power Transmitter might transition to a reinitialization state to reset or clear previous configurations for the previously-present Power Receiver.

This disclosure includes some optional implementations of information to enable a conditional standby state. For example, a Power Receiver might communicate information 312 during the discovery state 304 to enable the Power Transmitter to determine that the Power Receiver supports conditional standby state. The information 312 might indicate the appliance type. For example, the information 312 might indicate that the Power Receiver is an a “voluntary or reheat type” appliance. Alternatively, or additionally, the information 312 might indicate an ON/OFF profile of the appliance, such as the conditions or criteria for ON or OFF actions of the appliance, or an expected pattern of ON and OFF actions. In some implementations, the Power Receiver might communicate standby state control information 310 in a request to enter the conditional standby state. For example, the standby state control information 310 might indicate a sleeping time for the conditional standby state, an expected cooling time, or a recheck period, or any other information to enable the Power Transmitter to determine the sleeping time of the conditional standby state.

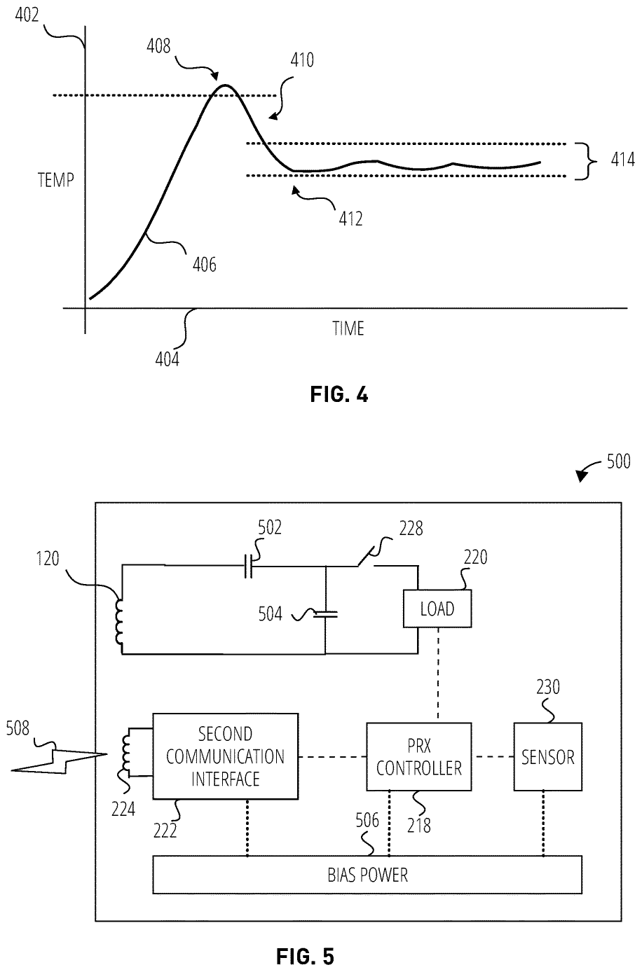

FIG. 4 illustrates an example temperature plot 406 associated with an appliance that might implement aspects of the present disclosure. The example temperature plot 406 might be an example of cooking and keep-warm operations of an example appliance, such as a rice cooker or slow cooker. The temperature plot 406 shows the temperature 402 of a vessel of the appliance in relation to the time 404. Initially, the appliance might perform a heating operation to reach a first temperature (shown at temperature 402). For the heating operation, the appliance might turn ON a load (such as a heating element of the appliance). For example, during the ON action, the appliance may be cooking food for a period of time (such as a “cooking period”). After reaching the first temperature, the appliance might initiate a cooling time 410. Although the first temperature to complete cooking is shown to last for a short time in FIG. 4, the appliance might maintain the temperature at or around the first temperature for an extended period of time. At the end of the cooking period and before entering a cooling period, the appliance can store status information in its non-volatile memory to indicate that the cooking is complete and reheating operations might follow (such as a “cooking complete and reheat needed” status). The status information can be reset when a new cooking action is initiated by the user. When the Power Transmitter wakes the Power Receiver, the appliance can check the status information to determine whether to perform a reheating option (such as the “reheat needed” status being true). If so, the appliance will alternate between “cooling period” and “reheating period” until a user action such as a new cooking action or user switch of the appliance is turned off. During the cooling time 410, the appliance might turn OFF the load.

The appliance might be configured to maintain a target temperature within a keep-warm range 414. Following the cooling time 410, when the temperature reaches a temperature threshold (such as reheat temperature 412), the appliance might turn ON the load to maintain a temperature of the vessel. To maintain the temperature within the keep-warm range 414, the appliance might alternate between ON actions and OFF actions to occasionally heat and cool the vessel, respectively.

FIG. 5 illustrates an example Power Receiver 500 in accordance with aspects of this disclosure. The example Power Receiver 500 may be an example of the Power Receiver 104 described with reference to FIG. 1 or FIG. 2. The Power Receiver 500 may be included in an appliance. The Power Receiver 500 might include a load 220 or the load 220 may be component of the appliance that also includes the Power Receiver 500.

The Power Receiver 500 includes a secondary coil 120, a second communication coil 224. a second communication interface 222, and a PRx controller 218 as described with reference to FIG. 2. In some implementations, the Power Receiver 500 may or may not include a rectifier (not shown in FIG. 2). FIG. 5 also shows a series capacitor 502 that may be coupled to one or more legs of the secondary coil 120. The example Power Receiver 500 includes a disconnect switch 228 connected in a series between one of the legs of the secondary coil 120 and the load 220. Although the disconnect switch 228 is shown as being connected in series with the series capacitor 502, other configurations are possible.

The Power Receiver 500 includes a sensor 230 configured to measure the temperature of a vessel (not shown) of the appliance. While the sensor 230 is described as a temperature sensor, the sensor 230 might be another type of sensor, such as a motion sensor, pressure sensor, humidity sensor, gas or chemical sensor, hall effect sensor, status sensor, or any other type of sensor that can provide input to the PRx controller 218 regarding a condition of the appliance.

The second communication interface 222 or other component (not shown) is configured to harvest bias power 506 from a communication signal 508 received by the second communication coil 224. The bias power 506 can provide power to the second communication interface 222. the PRx controller 218, and the sensor 230. For example, the bias power 506 might be in the range of 100 to 500 milliwatts, or any amount of power sufficient to operate the second communication interface 222, the PRx controller 218, and the sensor 230. Using the bias power 506, the PRx controller 218 can obtain a measurement or status signal from the sensor 230. The PRx controller 218 can determine whether the measurement or status signal satisfies a condition for an ON action of the load 220. For example, the sensor 230 might indicate a temperature at or below a threshold (such as the reheat temperature 412) associated with activating the load 220 to reheat the vessel. If the condition for activating the ON action of the load 220 is satisfied, the PRx controller 218 can cause the second communication interface 222 to communicate a power request to the Power Transmitter (not shown) to initiate power transfer. Otherwise, if the condition is not satisfied, the PRx controller 218 might maintain an OFF action of the load 220. In some implementations, the PRx controller 218 can communicate a request to the Power Transmitter to transition to the conditional standby state for a sleeping time. At expiration of the sleeping time, the Power Transmitter can wake the Power Receiver 500 by communicating a communication signal 508 to create bias power 506 once again, thereby enabling the PRx controller 218 to once again check the status of the condition for the ON action.

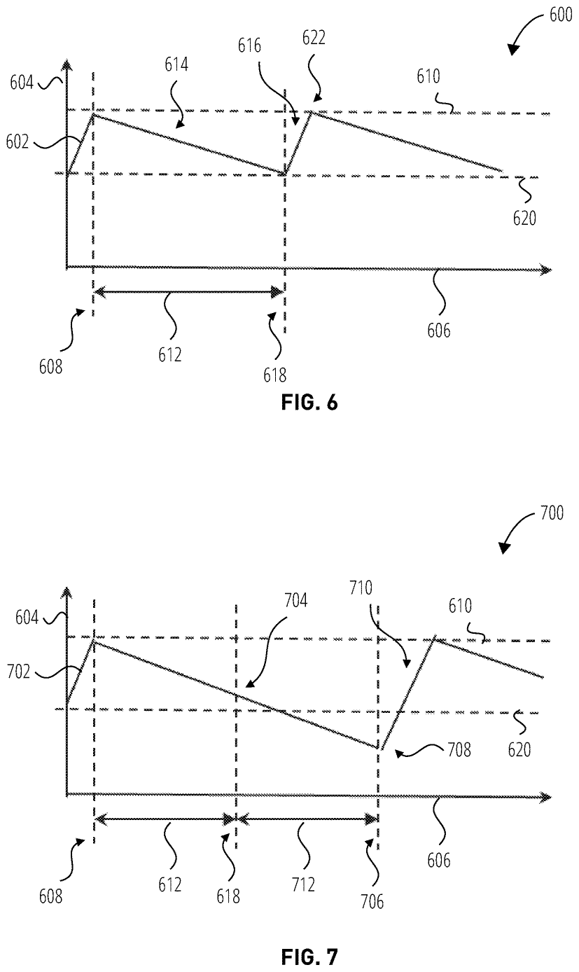

FIG. 6 and FIG. 7 illustrate example wake sequences and possible scenarios of a wireless power system. FIG. 6 shows a first wake sequence 600 in which a sleeping time expires at a time when the Power Receiver detects a condition triggering an ON action of the appliance. FIG. 7 shows a second wake sequence 700 when the condition for the ON action is not yet satisfied after expiration of the first sleeping time and the wireless power system enters a conditional standby state for a second sleeping time.

Beginning with FIG. 6, the first wake sequence 600 shows a temperature plot 602 showing the temperature 604 over a span of time 606. At the beginning of the temperature plot 602, the temperature is rising for a heating period that occurs before a first time (shown as t1 608). At the t1 608, the temperature reaches a first temperature 610 and the appliance enters a cooling period 614 in which the temperature gradually reduces. To minimize power consumption during the cooling period 614, the appliance can communicate a request to the Power Transmitter to enter a conditional standby state for a sleeping time 612 associated with the expected duration of the cooling period 614. The appliance can store status information in its memory to indicate that that the cooking was completed and that only “reheating” operations are needed until a new user action to either restart cooking or to switch off the appliance. In some implementations, the request explicitly indicates the sleeping time 612. Alternatively, or additionally, the request might be a state transition request (such as a NEXT/standby message) to prompt the conditional standby state. The state transition request might include an indicator to indicate that the requested standby state is a conditional standby state associated with a sleeping time. In some implementations, the sleeping time can be preconfigured using NDEF messages during discovery phase. Alternatively, or additionally, the sleeping time might be calculated by the Power Transmitter based on configuration information or other indicia related to the Power Receiver. For example, the Power Transmitter might identify the type of appliance and select a sleeping time 612 that is appropriate for that type of appliance. In some implementations, the appliance can communicate that it is a first type of appliance (such as a “voluntary or reheat type appliance”) associated with conditional ON and OFF periods.

At expiration of the sleeping time 612, the Power Transmitter wakes up the appliance at a second time (shown as t2 618). The wireless power system enters the connected state in which a communication signal (such as NFC) is beamed by the Power Transmitter. The appliance harvests bias power from the communication channel and wakes up. In the scenario of FIG. 6, the temperature of the vessel is at a second temperature 620. The second temperature 620 might be a condition for reheating the vessel (such as the reheat temperature 412 or a temperature threshold). As a result of the temperature being at the second temperature 620, the appliance might initiate an ON action or request Power Transmitter to move to power state to perform a reheating operation (shown at reheating period 616). The reheating operation includes the transfer of power from the Power Transmitter to the Power Receiver to operate a heating element of the appliance. Therefore, the reheating period 616 might correspond with a power state. After the temperature reaches the first temperature 610, the appliance might communicate another request (at time t3 622) to initiate another conditional standby state. For brevity the subsequent sleeping time (following the request at t3 622) is not shown but would operate the same as the sleeping time 612.

FIG. 7 illustrates the second wake sequence 700 of a wireless power system. Similar to FIG. 6, the temperature plot 702 shows the temperature 604 in relation to time 606. At t1608, the temperature has reached the first temperature 610 and the Power Receiver communicates a request to transition to a conditional standby state for the duration of a sleeping time 612. FIG. 7 differs from FIG. 6 in that the temperature at t2 618 (shown at temp 704) is above the second temperature 620 and the appliance might not trigger an ON action for the reheating operation. Instead, the Power Receiver might communicate another request to enter the conditional standby state for another instance of the sleeping time (shown as subsequent sleeping time 712). In some implementations, the subsequent sleeping time 712 might have the same duration as the preceding sleeping time 612.

In some other implementations, the duration of the subsequent sleeping time 712 might be different form the duration of the sleeping time 612 that precedes it. For example, the duration of the subsequent sleeping time 712 might be extended (or reduced) based on the quantity of consecutive conditional standby state periods. A potential technical advantage of adjusting the subsequent sleeping time 712 is that the wireless power system can adapt to particular types of appliances or to changes in ambient temperature in which the appliance is being used.

In some implementations, when the appliance sends the request for the subsequent sleeping time 712, the appliance can explicitly indicate the duration of the subsequent sleeping time 712. For example, the appliance might estimate the remaining amount of time at which the vessel is expected to cool to the second temperature 620. The appliance can indicate the duration of the subsequent sleeping time 712 so that the Power Transmitter will wake the Power Receiver at a time when the temperature will satisfy a condition for a reheating operation (and corresponding power state for ON action). A potential technical advantage of estimating and explicitly indicating the subsequent sleeping time 712 is that the Power Receiver can remain dormant for a longer or shorter period of time and minimize power consumption that would occur by waking when the temperature might not satisfy the condition.

Continuing with FIG. 7, at expiration of the subsequent sleeping time 712, the Power Transmitter wakes up the appliance at a third time (shown as t3 706). In the scenario of FIG. 6, the temp 708 at t3 706 is below the second temperature 620. Because the temp 708 satisfies a condition for reheating, the appliance might initiate an ON action to perform a reheating operation (shown at reheating period 710). The reheating operation includes the transfer of power from the Power Transmitter to the Power Receiver to operate a heating element of the appliance.

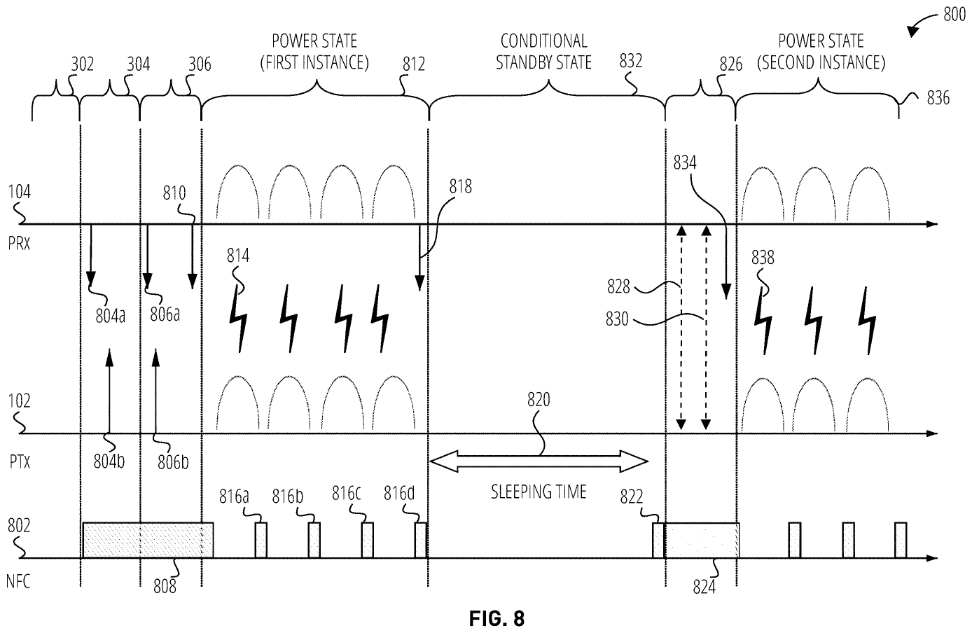

FIG. 8 illustrates a timing diagram 800 and associated operations in various states of a wireless power system. The timing diagram 800 is used to describe the operations of a Power Receiver 104 (PRx) and a Power Transmitter 102 (PTx) Although described as operations of the Power Receiver 104 and the Power Transmitter 102, it should be apparent that the operations might be performed by a PTx controller and a PRx controller, respectively. The Power Receiver 104 and the Power Transmitter 102 may follow the state diagram of various operating states, as described with reference to FIG. 3. FIG. 8 also shows the state of the communication channel 802 (NFC) in relation to the described operations.

For brevity, the details of the initial instance of the standby state 302, the discovery state 304, and the connected state 306 are not illustrated in detail in FIG. 8. During the standby state 302, a user may place an appliance having the Power Receiver 104 in an interface space of the Power Transmitter 102. The Power Transmitter 102 detects the Power Receiver 104 and enters the discovery state. The discovery state 304 might include one or more discovery state messages 804a, 804b (such as identification and configuration, NDEF messages) and a state transition request message. The appliance, using the NDEF message indicates that it is a “conditional ON/OFF type” of appliance and also might communicate the sleeping time. A “NEXT” message is a state transition request message that indicates a request to transition to another state and the requested state (for example, the “NEXT/con” message is a state transition request message to transition to the connected state). The recipient of a state transition request message may respond with a response message (“RESP/ok”). The “RESP” message might indicate okay (“ok”), not okay (“nok”), not defined (“nd”), or busy (“bsy”). In some implementations, the “RESP” message is a response that can indicate acknowledgement (“ack”), non-acknowledgement (“nak”) or not defined (“nd”).

Details for the connected state 306 are omitted from FIG. 8 for brevity. The connected state 306 might include one or more connected state messages 806a (such as power negotiation messages). Furthermore, the Power Transmitter 102 might perform a FOD procedure during the connected state 306 to determine that no foreign objects are present. At some point, the Power Receiver 104 transmits a power request message 810 to initiate power transfer in a first instance of the power state 812. During the first instance of the power state 812, the Power Transmitter 102 transmits a wireless power signal 814 to the Power Receiver 104. On the communication channel 802, communication 808 might occur during the pre-power states. Although shown as a continuous communication 808, the communication 808 might include periods of inactivity, such as during FOD or pre-power coupling factor measurement periods. During the power state, the communication channel 802 might use communication slots 816a, 816b, 816c, 816d at zero-cross events of the wireless power signal 814. Not all zero cross events might be used for inserting a communication slot.

In the example of FIG. 8, when the initial heating operation is complete, the Power Receiver 104 might communicate a request message 818 to transition to the conditional standby state 832. During the sleeping time 820, there might not be a wireless power signal or communication occurring. Thus, the Power Receiver 104 might power down and minimize power consumption. At expiration of the sleeping time 820, the Power Transmitter 102 might activate the communication channel 802 to transmit a communication 822. The communication 822 provides energy for the Power Receiver 104 to harvest a bias power to activate its PRx controller, sensor, and communication interface.

In some implementations, the Power Transmitter 102 and the 104 might perform one or more pre-power operations 828, 830 associated with pre-power states 826 (such as the discovery state and the connected state). The Power Transmitter may verify that the appliance on the interface surface is the same as the one that was left before entering the sleeping time 820. For example, the Power Transmitter can compare the appliance identification (ID) information with a previous appliance ID information stored before the conditional standby state. If a new appliance is detected (meaning the appliance ID information is not the same as before the conditional standby state), then the Power Transmitter will start with a fresh discovery and connected state with the new appliance. Otherwise, if the same appliance is present, the Power Transmitter 102 might continue with the pre-power operations 828, 830. In some implementations, the pre-power operations 828, 830 might include an FOD to determine that no foreign object was introduced during the sleeping time 820. The Power Transmitter also may verify that the appliance alignment on interface surface is within an acceptable range in case the appliance might have moved during the sleeping time 820. In some implementations, the pre-power operations 828, 830 might omit one or more operations that would normally have occurred during a first instance of the pre-power states.

Continuing with FIG. 8, if the Power Receiver 104 determines to activate an ON action of the appliance. the Power Receiver 104 can communicate a power request message 834 to transition to a second instance of the power state 836 in which the Power Transmitter 102 transmits wireless power signal 838 to the Power Receiver 104 for a reheating operation. In an alternative not shown in FIG. 8, the Power Receiver 104 might determine to maintain an OFF action of the appliance. Instead of communicating the power request message 834, the Power Receiver 104 might transmit a subsequent request (not shown) to begin another conditional standby state for subsequent sleeping time.

Although the example scenario illustrated in FIG. 8 shows a first instance of the power state 812 occurring before the conditional standby state 832, it is possible that the conditional standby state 832 occurs following the connected state 306 and before the first instance of the power state 812. For example, a user might place the appliance on the Power Transmitter 102 with a delay timer that schedules the ON action of the appliance for a later time. The Power Receiver 104 and the Power Transmitter 102 can proceed through the standby state 302, the discovery state 304 and the connected state 306. However, if the delay timer has not yet triggered the ON action, the Power Receiver 104 can transmit the request message 818 to enter the conditional standby state 832 in the connected state 306. A potential technical advantage of this feature is that an appliance can have a scheduled or delayed activation time. An example of such an appliance might be a kettle, rice cooker, or slow cooker configured to begin a heating operation at a later time, and potentially when the appliance is unattended, so that the heating operation completes at a time that is chosen by the end user.

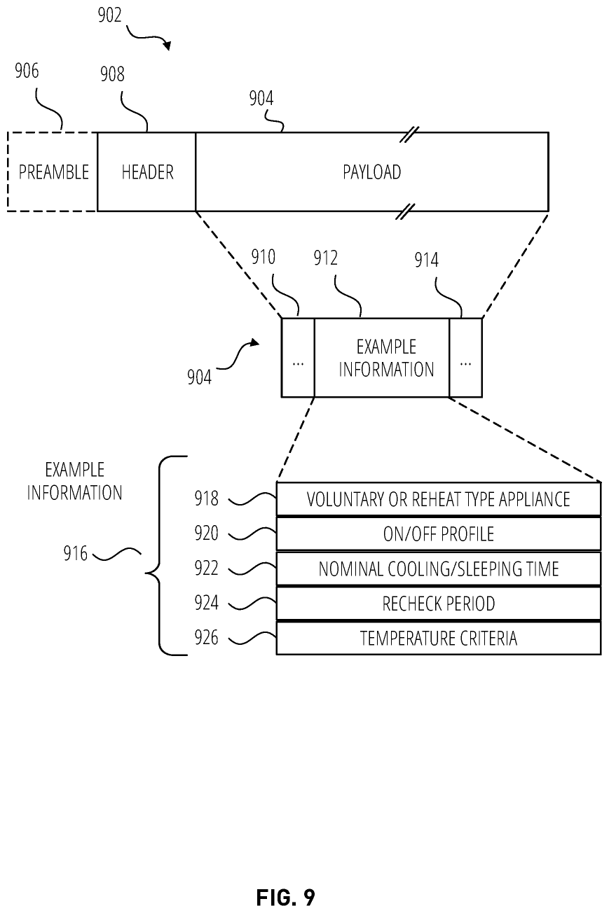

FIG. 9 depicts a conceptual diagram of an example message according to some aspects of this disclosure. For example, the message 902 may be sent from a Power Receiver to a Power Transmitter. In some implementations. the message 902 may be part of another message, such as a configuration message. In some other implementations, the message 902 may be transmitted during the connected state when the appliance is repowered by the Power Transmitter following a cooling period. The message 902 may include a header 908 and a payload 904. In some implementations, the header 908 includes frame control information indicating that the message 902 includes conditional standby state information. In some implementations, the message 902 may include a preamble 906 indicating the start of the message 902. The payload 904 includes one or more information elements 910, 912, and 914.

Several example information elements 916 are illustrated in FIG. 9. For example, the conditional standby state information might indicate that the appliance is a “voluntary or reheat type appliance” 918, on/off profile 920, a nominal cooling/sleeping time 922, a recheck period 924, or a temperature criteria 926. This information might be communicated during a connected state as part of an initial configuration or might be communicated from the Power Receiver to the Power Transmitter as part of a request message to enter the conditional standby state.

The information indicating that the appliance is a “voluntary or reheat type appliance” 918 might indicate a first type from among several types of appliance. It should be apparent that the term “voluntary or reheat type appliance” is provided as an example for illustrative purposes, and other terms are possible, such as appliance type indicator, conditional ON/OFF appliance, automated-type appliance, or other terms.

The information indicating an ON/OFF profile 920, the nominal cooling/sleeping time 922, or the recheck period 924 might assist the Power Transmitter in selecting or disabling the function of selecting a duration of the sleeping time for a conditional standby state (such as enabling or disabling the reheating function of the appliance).

In some implementations, the appliance might indicate a temperature criteria 926 so that the Power Transmitter can determine whether to activate the ON action of the appliance. For example, when the Power Transmitter wakes the Power Receiver, the Power Receiver can communicate a temperature measurement from a sensor. The Power Transmitter (rather than the Power Receiver) can compare the temperature measurement to the temperature criteria 926 to determine when to activate the NFC and so that the temperature criterion would have satisfied the power state ON action of the appliance. A potential technical advantage of this approach is that the Power Receiver can reduce or possibly eliminate operation of a PRx controller that would otherwise occur when the Power Transmitter wakes the Power Receiver.

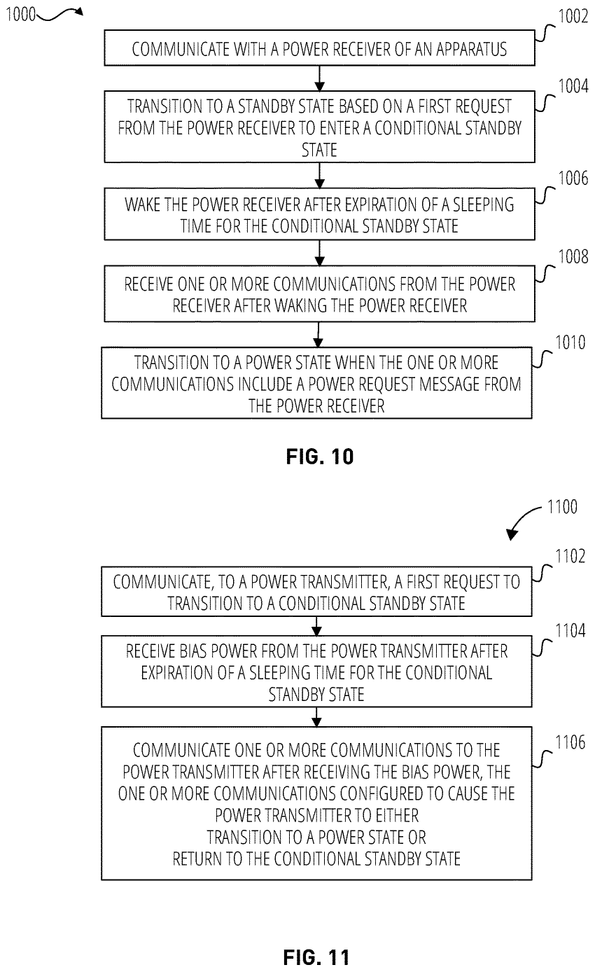

FIG. 10 illustrates a flow chart with example operations 1000 of a Power Transmitter in accordance with some aspects of this disclosure. For example, the flow chart might be performed by the Power Transmitter 102 described with reference to other Figures of this disclosure. In block 1002, the Power Transmitter communicates with a Power Receiver of an apparatus. In block 1004, the Power Transmitter transitions to a standby state based on a first request from the Power Receiver to enter a conditional standby state. In block 1006, the Power Transmitter wakes the Power Receiver after expiration of a sleeping time for the conditional standby state. In block 1008, the Power Transmitter receives one or more communications from the Power Receiver after waking the Power Receiver. In block 1010, the Power Transmitter transitions to a power state when the one or more communications include a power request message from the Power Receiver.

FIG. 11 illustrates a flow chart with example operations 1100 of a Power Receiver in accordance with some aspects of this disclosure. For example, the flow chart might be performed by the Power Receiver 104 described with reference to other Figures of this disclosure. In block 1102, the Power Receiver communicates, to a Power Transmitter, a first request to transition to a conditional standby state. In block 1104, the Power Receiver receives bias power from the Power Transmitter after expiration of a sleeping time for the conditional standby state. In block 1106, the Power Receiver communicates one or more communications to the Power Transmitter after receiving the bias power, the one or more communications configured to cause the Power Transmitter to either transition to a power state or return to the conditional standby state.

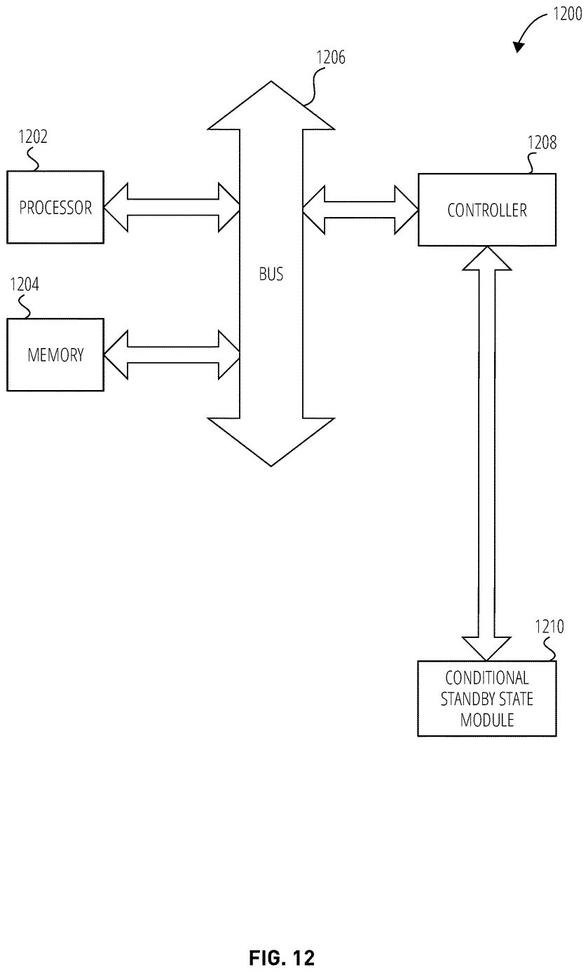

FIG. 12 illustrates a block diagram of an example apparatus for use in a wireless power system. In some implementations, the apparatus 1200 may be a wireless power transmission apparatus (such as the Power Transmitter 102) described herein. The apparatus 1200 can include a processor 1202 (possibly including multiple processors, multiple cores, multiple nodes, or implementing multi-threading, etc.). The apparatus 1200 also can include a memory 1204. The memory 1204 may be system memory or any one or more of the possible realizations of computer-readable media described herein. The apparatus 1200 also can include a bus 1206 (such as PCI, ISA, PCI-Express, HyperTransport®, InfiniBand®, NuBus.® AHB, AXI, etc.).

The apparatus 1200 may include one or more controllers 1208 (such as a PTx controller). In some implementations, the controller 1208 can be distributed within the processor 1202, the memory 1204, and the bus 1206. The controller 1208 may perform some or all of the operations described herein. For example, the controller 1208 may implement the processes described with reference to any one of FIG. 1 through FIG. 10, or any combination thereof.

The memory 1204 can include computer instructions executable by the processor 1202 to implement the functionality of the implementations described herein. Any one of these functionalities may be partially (or entirely) implemented in hardware or on the processor 1202. For example, the functionality may be implemented with an application specific integrated circuit, in logic implemented in the processor 1202, in a co-processor on a peripheral device or card, etc. Further, realizations may include fewer or additional components not illustrated in FIG. 12. The processor 1202, the memory 1204, and the controller 1208 may be coupled to the bus 1206. Although illustrated as being coupled to the bus 1206, the memory 1204 may be coupled to the processor 1202 or the controller 1208.

The apparatus 1200 also includes a conditional standby state module 1210. The conditional standby state module 1210 might implement any of the operations described with reference to FIG. 1 through FIG. 7. For example, the conditional standby state module 1210 might process a request message from a Power Receiver requesting to enter a conditional standby state. The conditional standby state module 1210 might implement a timer or counter to determine when an expiration of the sleeping time occurs. The conditional standby state module 1210 might initiate one or more operations to wake the Power Receiver after expiration of the sleeping time.

FIG. 1 through FIG. 12 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (identified as clauses for reference).

### Clauses

Clause 1. A method by a Power Transmitter of a wireless power system, including: communicating with a Power Receiver of an apparatus; transitioning to a standby state based on a first request from the Power Receiver to enter a conditional standby state; waking the Power Receiver after expiration of a sleeping time for the conditional standby state; receiving one or more communications from the Power Receiver after waking the Power Receiver; and transitioning to a power state when the one or more communications include a power request message from the Power Receiver.
Clause 2. The method of clause 1, further including, when the one or more communications include a second request to transition to the conditional standby state: refraining from transitioning to the power state; and returning to the conditional standby state based on the second request.
Clause 3. The method of clause 2, where returning to the conditional standby state includes: transitioning to the standby state for subsequent duration of the sleeping time; and waking the Power Receiver after expiration of the subsequent duration of the sleeping time.
Clause 4. The method of clause 2, where the second request indicates a new sleeping time duration, and where returning to the conditional standby state includes: transitioning to the standby state for the new sleeping time duration; and waking the Power Receiver after expiration of the new sleeping time duration.
Clause 5. The method of any one of clauses 1 to 4, further including: receiving, from the Power Receiver, an indication that the Power Receiver is in a first type of appliance that implements the sleeping time between instances of the power state.
Clause 6. The method of clause 5, where receiving the indication includes receiving a Near Field Communication (NFC) Data Exchange Format (NDEF) message that includes a field having the indication.
Clause 7. The method of any one of clauses 1 to 6, where the first request indicates the sleeping time.
Clause 8. The method of any one of clauses 1 to 6, where the first request indicates an expected cooling time post a heating operation of the appliance, the method further including: calculating the sleeping time for the conditional standby state based, at least in part, on the expected cooling time.
Clause 9. The method of any one of clauses 1 to 8, where the first request indicates a target temperature for a reheating operation of the appliance, the method further including: transitioning to the power state when the one or more communications include a temperature measurement that is below the target temperature.
Clause 10. The method of any one of clauses 1 to 9, further including: negotiating the sleeping time with the Power Receiver via one or more messages before receiving the first request to enter the conditional standby state.
Clause 11. The method of clause 10, where the negotiating the sleeping time includes: receiving a first value from the Power Receiver, the first value indicating at least one of a nominal cooling time, a nominal sleeping time, or a requested sleeping time; communicating a second value from the Power Transmitter to the Power Receiver, the second value indicating a proposed sleeping time based on one or more parameters of the Power Transmitter; and setting the sleeping time based, at least in part, on the first value and the second value.
Clause 12. The method of any one of clauses 1 to 11, where waking the Power Receiver includes: establishing communication with the Power Receiver; and performing one or more operations associated with a discovery state and a connected state, the one or more operations including at least a foreign object detection (FOD).
Clause 13. The method of clause 12, where performing the one or more operations includes: determining that the Power Receiver is present in an operating environment of the Power Transmitter and that no foreign object is detected by the FOD; and omitting at least one operation that would otherwise be performed during the discovery state or the connected state.
Clause 14. The method of any one of clauses 1 to 13, further including, after expiration of a respective sleeping time for a corresponding conditional standby state: determining that the Power Receiver is moved, that the Power Receiver is no longer present in an operating environment of the Power Transmitter, or that a foreign object has been introduced during the conditional standby state; and resetting the Power Transmitter to a reinitialization state.
Clause 15. A Power Transmitter, including: a controller configured to implement a method according to any one of clauses 1 to 11.
Clause 16. A method by a Power Receiver of an apparatus for use in a wireless power system, the method including: communicating, to a Power Transmitter, a first request to transition to a conditional standby state; receiving bias power from the Power Transmitter after expiration of a sleeping time for the conditional standby state; and communicating one or more communications to the Power Transmitter after receiving the bias power, the one or more communications configured to cause the Power Transmitter to either transition to a power state or return to the conditional standby state.
Clause 17. The method of clause 16, where the one or more communications include a power state transition request message to cause the Power Transmitter to transition to the power state.
Clause 18. The method of clause 16, where the one or more communications include a second request to cause the Power Transmitter to return to the conditional standby state for another duration of the sleeping time or for a new sleeping time duration indicated in the second request.
Clause 19. The method of any one of clauses 16 to 18, further including: communicating, from the Power Receiver to the Power Transmitter, an indication that the Power Receiver is in a first type of appliance that implements the sleeping time between instances of the power state.
Clause 20. The method of any one of clauses 16 to 19, where the first request indicates at least one of: an explicit value of the sleeping time, an expected cooling time for a heating operation of the appliance, a target temperature for a reheating operation of the appliance, or other indicia to enable the Power Transmitter to calculate a condition for waking the Power Receiver from the conditional standby state.
Clause 21. The method of any one of clauses 16 to 20. further including: negotiating the sleeping time with the Power Transmitter via one or more messages before communicating the first request to transition to the conditional standby state.
Clause 22. A Power Receiver, including: a controller configured to implement a method according to any one of clauses 16 to 21.

Another innovative aspect of the subject matter described in this disclosure can be implemented as a computer-readable medium having stored therein instructions which, when executed by a processor, causes the processor to perform any one of the above-mentioned functionalities.

Another innovative aspect of the subject matter described in this disclosure can be implemented as a system having means for implementing any one of the above-mentioned functionalities.

Another innovative aspect of the subject matter described in this disclosure can be implemented as an apparatus having one or more processors configured to perform one or more operations from any one of the above-mentioned methods.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration, In some implementations, particular processes, operations and methods may be performed by circuitry that is specific to a given function.

As described above, some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order. this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously. or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method by a Power Transmitter of a wireless power system, comprising:
communicating with a Power Receiver of an apparatus;
receiving a first value from the Power Receiver, the first value indicating at least one of a nominal cooling time, a nominal sleeping time, or a requested sleeping time;
receiving a first request from the Power Receiver to enter a temporary standby state;
transitioning to the temporary standby state based on the first request;
setting a sleeping time for the temporary standby state based, at least in part, on the first value;
waking the Power Receiver after expiration of the sleeping time;
receiving one or more communications from the Power Receiver after waking the Power Receiver; and
transitioning to a power state when the one or more communications include a power request message from the Power Receiver.

2. The method of claim 1, further comprising, when the one or more communications include a second request to transition to the temporary standby state:
refraining from transitioning to the power state; and
returning to the temporary standby state based on the second request.

3. The method of claim 2, wherein returning to the temporary standby state includes:
transitioning to the temporary standby state for subsequent duration of the sleeping time or a new sleeping time duration; and
waking the Power Receiver after expiration of the subsequent duration or the new sleeping time duration.

4. (canceled)

5. The method of claim 1, comprising:
receiving, from the Power Receiver, an indication that the Power Receiver is in a first type of appliance that implements the sleeping time between instances of the power state.

6-7. (canceled)

8. The method of claim 1, wherein the first request indicates an expected cooling time following a heating operation of the apparatus, the method further comprising:
calculating the sleeping time for the temporary standby state based, at least in part, on the expected cooling time.

9. The method of claim 1, wherein the first request indicates a target temperature for a reheating operation of the apparatus, the method further comprising:
transitioning to the power state when the one or more communications include a temperature measurement that is below the target temperature.

10. The method of claim 1, further comprising:
negotiating the sleeping time with the Power Receiver via one or more messages before receiving the first request to enter the temporary standby state, wherein the negotiating includes communicating a second value from the Power Transmitter to the Power Receiver, the second value indicating a proposed sleeping time based on one or more parameters of the Power Transmitter; and wherein the setting the sleeping time is further based, at least in part, on the second value.

11. (canceled)

12. The method of claim 1, wherein waking the Power Receiver includes:
establishing communication with the Power Receiver; and
performing one or more operations associated with a discovery state and a connected state.

13. The method of claim 12, further comprising, after waking the Power Receiver:
performing one or more operations for a foreign object detection (FOD);
determining that the Power Receiver is present in an operating environment of the Power Transmitter and that no foreign object is detected by the FOD; and
omitting at least one operation that would otherwise be performed during the discovery state or the connected state.

14. The method of claim 1, further comprising:
determining that the Power Receiver is moved, that the Power Receiver is no longer present in an operating environment of the Power Transmitter, or that a foreign object has been introduced during the temporary standby state; and
resetting the Power Transmitter to a reinitialization state.

15. A method by a Power Receiver of an apparatus for use in a wireless power system, the method comprising:
communicating, to a Power Transmitter, a first value indicating at least one of a nominal cooling time, a nominal sleeping time, or a requested sleeping time;
communicating, to the Power Transmitter, a first request to transition to a temporary standby state; setting a sleeping time for the temporary standby state based, at least in part, on the first value;
transitioning to the temporary standby state based on the first request;
waking up after expiration of the sleeping time; and
communicating one or more communications to the Power Transmitter to cause the Power Transmitter to either transition to a power state or return to the temporary standby state.

16. The method of claim 15, wherein the one or more communications include a power state transition request message to cause the Power Transmitter to transition to the power state.

17. The method of claim 15, wherein the one or more communications include a second request to cause the Power Transmitter to return to the temporary standby state for another duration of the sleeping time or for a new sleeping time duration indicated in the second request.

18. The method of claim 15, further comprising:
receiving bias power from the Power Transmitter after expiration of a sleeping time for the temporary standby state.

19. The method of claim 15, wherein the first request indicates at least one of:
an expected cooling time for a heating operation of the apparatus,
a target temperature for a reheating operation of the apparatus, or
other indicia to enable the Power Transmitter to calculate a condition for waking the Power Receiver from the temporary standby state.

20-34. (canceled)

35. A Power Receiver comprising:
a communication unit configured to:
communicate, to a Power Transmitter, a first value indicating at least one of a nominal cooling time, a nominal sleeping time, or a requested sleeping time;
communicate, to the Power Transmitter, a first request to transition to a temporary standby state; and
a Power Receiver (PRx) controller configured to:
set a sleeping time for the temporary standby state based, at least in part, on the first value,
transition to the temporary standby state based on the first request,
wake up after expiration of the sleeping time, and
cause the communication unit to communicate one or more communications to the Power Transmitter to cause the Power Transmitter to either transition to a power state or return to the temporary standby state.

36. The Power Receiver of claim 35, wherein the one or more communications include a power state transition request message to cause the Power Transmitter to transition to the power state.

37. The Power Receiver of claim 35, wherein the one or more communications include a second request to cause the Power Transmitter to return to the temporary standby state for another duration of the sleeping time or for a new sleeping time duration indicated in the second request.

38. The Power Receiver of claim 37, wherein the communication unit is further configured to communicate, from the Power Receiver to the Power Transmitter, an indication that the Power Receiver is in a first type of appliance that implements the sleeping time between instances of the power state.

39. The Power Receiver of claim 38, wherein the first request indicates at least one of:
an expected cooling time for a heating operation of the appliance,
a target temperature for a reheating operation of the appliance, or
other indicia to enable the Power Transmitter to calculate a condition for waking the Power Receiver from the temporary standby state.

40. (canceled)
